(19) United States
(12) Patent Application Publication
(10) Pub. No.: US 2026/0269575 A1
(43) Pub. Date: Sep. 10, 2026

(54) BREAKER PANELS AND RETROFITTING BREAKER PANELS

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 19/075,009

(22) Filed: Mar. 10, 2025

(51) Int. Cl. H02B 1/04; H02B 3/00

(52) U.S. Cl. CPC H02B 1/04; H02B 3/00

(57) ABSTRACT

A method of retrofitting includes removing a main breaker from a main receptacle of a breaker panel interior, and installing a main switching device that includes a relay into the main receptacle of the breaker panel interior. The interior includes a first line bus and a second line bus and a plurality of connectors configured to receive branch devices for controlling individual circuits. In an ON state of the relay, the relay can electrically connect first and second relay lines in to the first and second line main busses. In an OFF state of the relay, the relay can electrically isolate the first and second relay lines in from the first and second line main busses. The original main breaker can be connected outside the breaker panel, e.g. for use as a firefighter disconnect.

### BACKGROUND

### 1. Field

The present disclosure relates to breaker panels, load centers, and the like, and more particularly to systems and methods for disconnecting residential breaker panels such as NAM panels from utilities, e.g. to operate a residence as an island separate from the grid or the like.

### 2. Description of Related Art

Residential power systems have increased in complexity as it is increasingly typical to include power sources other than the utility grid. Emergency generators, batteries, solar panels, electric vehicles, and the like are becoming common place. These devices can generate a net surplus of power and can be used to time-shift peak loads to reduce costs. These activities can allow for reduced power cost for a residence, and can even generate income. However, the inclusion of all of these devices in a traditional breaker panel can create complications where automation would be beneficial.

The conventional techniques have been considered satisfactory for their intended purpose. However, there is an ever-present need for improved systems and methods for breaker panels and for retrofitting existing breaker panels to have new functionality. This disclosure provides a solution for this need.

### SUMMARY

A switching device includes a relay. A first lug is electrically connected to the relay by a first relay line in. A second lug is electrically connected to the relay by a second relay line in. A first bus connector is electrically connected to the relay. A second bus connector is electrically connected to the relay. In an ON state of the relay, the relay is configured to electrically connect the first relay line in to the first bus connector and to electrically connect the second relay line in to the second bus connector. In an OFF state of the relay, the relay is configured to electrically isolate the first relay line in from the first bus connector and to electrically isolate the second relay line in from the second bus connector.

A housing can be included with a mounting point configured for mounting the housing to a breaker panel interior. The relay can be inside the housing. The first relay line in can extend from the first lug outside the housing to the relay inside the housing. The second relay line in can extend from the second lug outside the housing to the relay inside the housing. A lockout tagout (LOTO) switch can be operatively connected to the relay for manual control of the relay for switching the relay among the ON state and the OFF state.

A communications PCBA (printed circuit board assembly) can include at least one input/output port operatively connected to control the relay based on input received by the communications PCBA. A first line current transformer (CT) can be operatively connected to the first line in to generate feedback signals indicative of current in the first relay line in. A second line CT can be operatively connected to the second relay line in to generate feedback signals indicative of current in the second relay line in. A controller PCBA (printed circuit board assembly) can be operatively connected to the first line CT, to the second line CT, and to the relay for control of the relay, switching the relay back and forth between the ON state and the OFF state based on the feedback signals from the first line CT and from the second line CT.

A system includes a breaker panel. An interior is mounted in the breaker panel. The interior includes a first line bus and a second line bus and a plurality of connectors configured to receive branch devices for controlling individual circuits. A main switching device includes a relay. A first lug is electrically connected to the relay by a first relay line in. A second lug is electrically connected to the relay by a second relay line in. A first bus connector is electrically connected to the relay and to the first line bus. A second bus connector is electrically connected to the relay and to the second line bus. In an ON state of the relay, the relay is configured to electrically connect the first relay line in to the first bus connector and to electrically connect the second relay line in to the second bus connector. In an OFF state of the relay, the relay is configured to electrically isolate the first relay line in from the first bus connector and to electrically isolate the second relay line in from the second bus connector.

The main switching device can include a housing with a mounting point mounted to the interior. The relay can be inside the housing. The first relay line in can extend from the first lug outside the housing to the relay inside the housing. The second relay line in can extend from the second lug outside the housing to the relay inside the housing. The housing can be accommodated in a receptacle of the interior configured to receive a device of a QOM2 form factor. The main switching device can include a lockout tagout (LOTO) switch operatively connected to the relay for manual control of the relay for switching the relay among the ON state and the OFF state. The main switching device can include a communications PCBA (printed circuit board assembly) including at least one input/output port operatively connected to control the relay based on input received by the communications PCBA.

A generator control switch (GCS) device can be mounted to the interior. The GSC can include a GCS control configured to switch the GCS device between a generator ON state for electrically connecting a generator to the first and second line main busses and a generator OFF state for electrically isolating the generator from the first and second line main busses. The GCS control can include an input output connector operatively connected to the at least one input/output port of the main switching device for control of the GCS device by the main switching device.

The main switching device can include a first line current transformer (CT) operatively connected to the first relay line in to generate feedback signals indicative of current in the first relay line in. A second line CT can be operatively connected to the second relay line in to generate feedback signals indicative of current in the second relay line in. A controller PCBA (printed circuit board assembly) can be operatively connected to the first line CT, to the second line CT, and to the relay for control of the relay, switching the relay back and forth between the ON state and the OFF state based on the feedback signals from the first line CT and from the second line CT. A fireman disconnect device can be electrically connected to first and second main lines outside of the panel for allowing disconnection of the first and second line main busses from a utility grid.

A method of retrofitting includes removing a main breaker from a main receptacle of a breaker panel interior, and installing a main switching device that includes a relay into the main receptacle of the breaker panel interior. The method can include installing the main breaker outside of the breaker panel, electrically in series between a utility grid and the main switching device for use as a firefighter disconnect. The method can include mounting a generator control switch (GCS) device to the interior, and electrically connecting the GCS device to first and second line main busses of the interior for suppling generator power to the first and second line main busses with the GSC device in a generator ON state, and disconnecting generator power from the first and second line main busses with the GCS device in a generator OFF state. The method can include operatively connecting the BCS to the main switching device for control of the generator ON state and the generator OFF state by the main switching device.

Before removing the main breaker, a cover can be removed from the breaker panel to access the interior. The cover can include one or more branch device apertures therethrough for branch devices and a main aperture therethrough dimensioned to fit a face of the main breaker. A face of the main switching device can be dimensioned to fit the main aperture. The cover can be reinstalled after installing the main switching device, with a face of the main switching device fitting the main aperture without modifying the main aperture.

Prior to removing the cover from the breaker panel to access the interior, a plurality of branch devices can already be in position on the first and second line main busses and can be already connected with respective wires to circuits for control of ON/OF states of the circuits. The plurality of branch devices can have faces that fit the one or more branch device apertures. All of the branch devices and their respective wires can remain installed to the interior before, during, and after removing the cover and reinstalling the cover. The method can include connecting an external device to the main switching device to download usage metrics from the main switching device, control the main switching device, and/or upload a program into the main switching device.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a perspective view of an embodiment of a system constructed in accordance with the present disclosure, showing a breaker panel with a relay-based main switching device;

FIG. 2 is a perspective view of a system prior to retrofitting to make a system as in FIG. 1, showing the interior with the cover removed with an original main breaker to be removed;

FIG. 3 is a perspective view of the system of FIG. 2, schematically showing removal of the original main switch;

FIG. 4 is a perspective view of the system of FIG. 3, showing the relay-based main switching device installed onto the interior;

FIG. 5 is a perspective view of the system of FIG. 4, showing a generator control switch (GCS) device installed onto the interior;

FIG. 6 is a perspective view of a portion of the system of FIG. 1, showing the relay-based main switching device;

FIG. 7 is a perspective view of the main switching device of FIG. 6, showing the housing removed;

FIG. 8 is a perspective view of a portion of the system of FIG. 1, showing the GCS device;

FIG. 9 is a perspective view of the GCS of FIG. 8, showing the GCS device lugs; and

FIG. 10 is a perspective view of the GCS device of FIG. 8, showing the GCS housing removed.

### DETAILED DESCRIPTION OF THE PREFERRED EMBODIMENTS

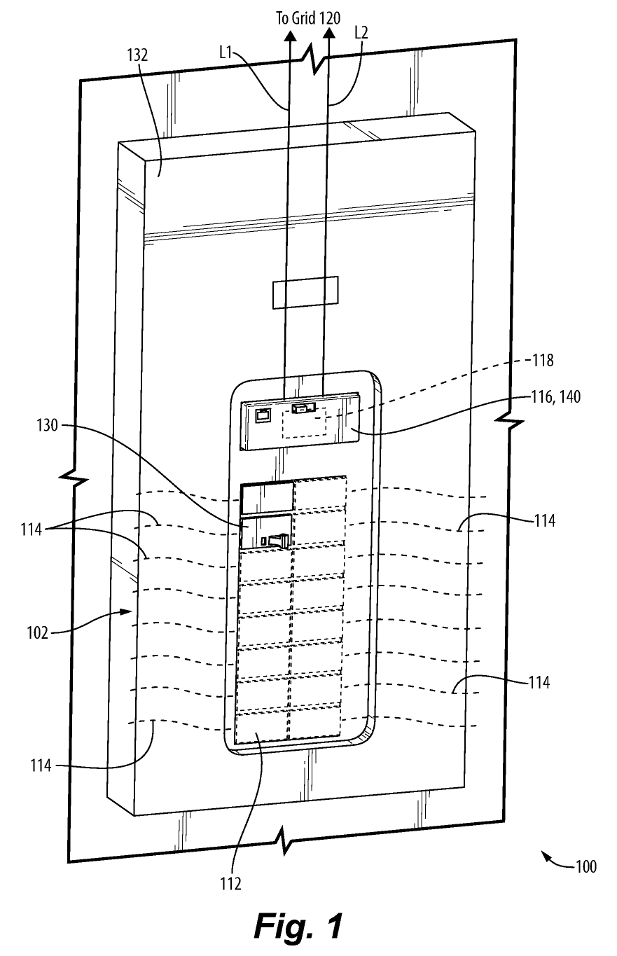

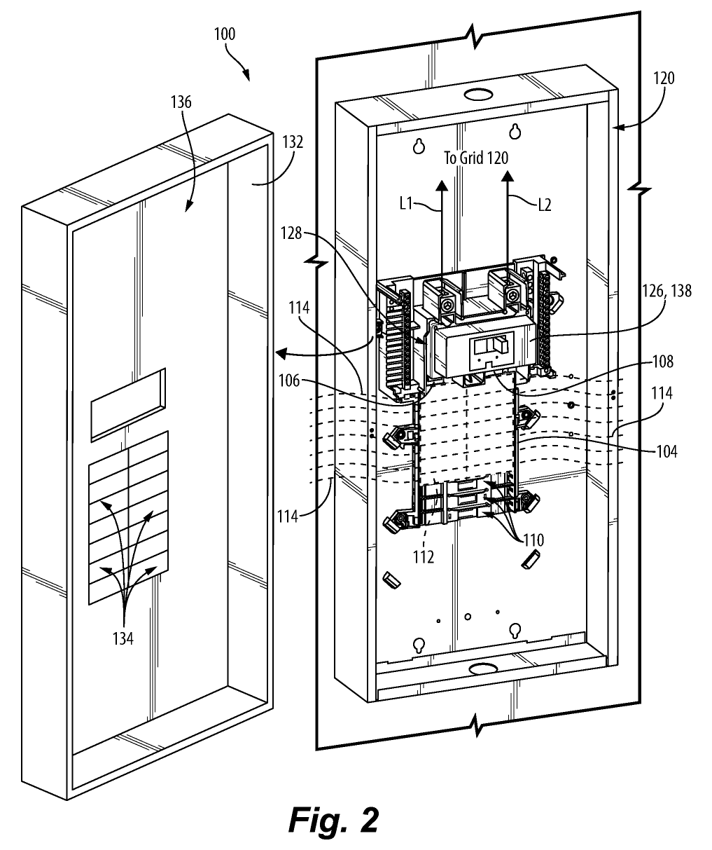

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-10, as will be described. The systems and methods described herein can be used to provide a relay based main switching device, e.g. for automation for functionality like time shifting of peak loads, and a method of retrofitting traditional breaker panels to incorporate the relay based main switching device.

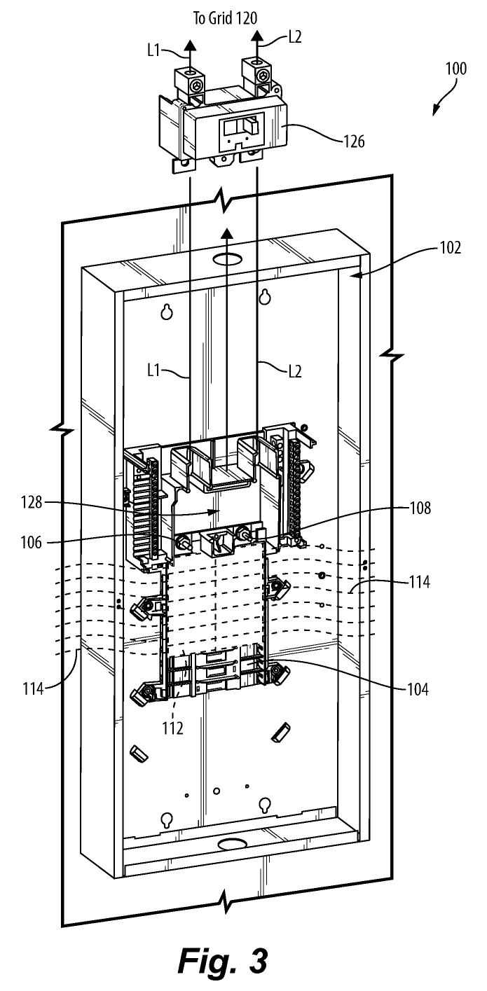

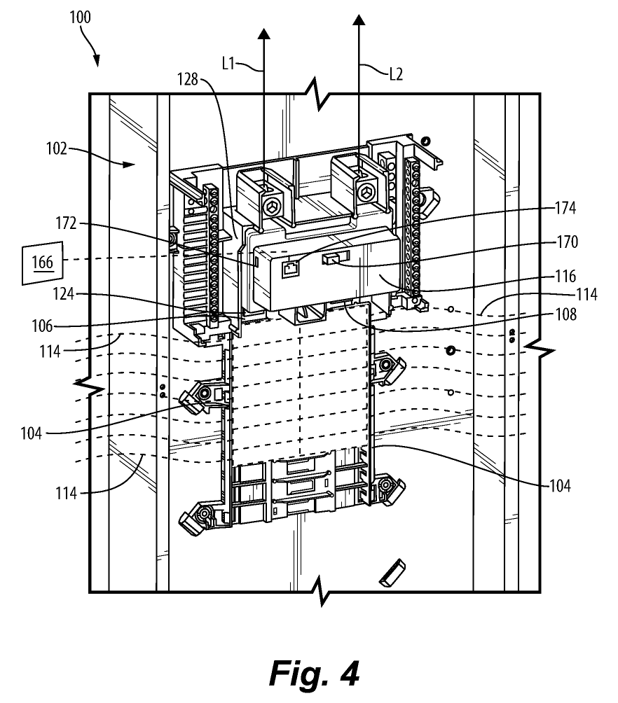

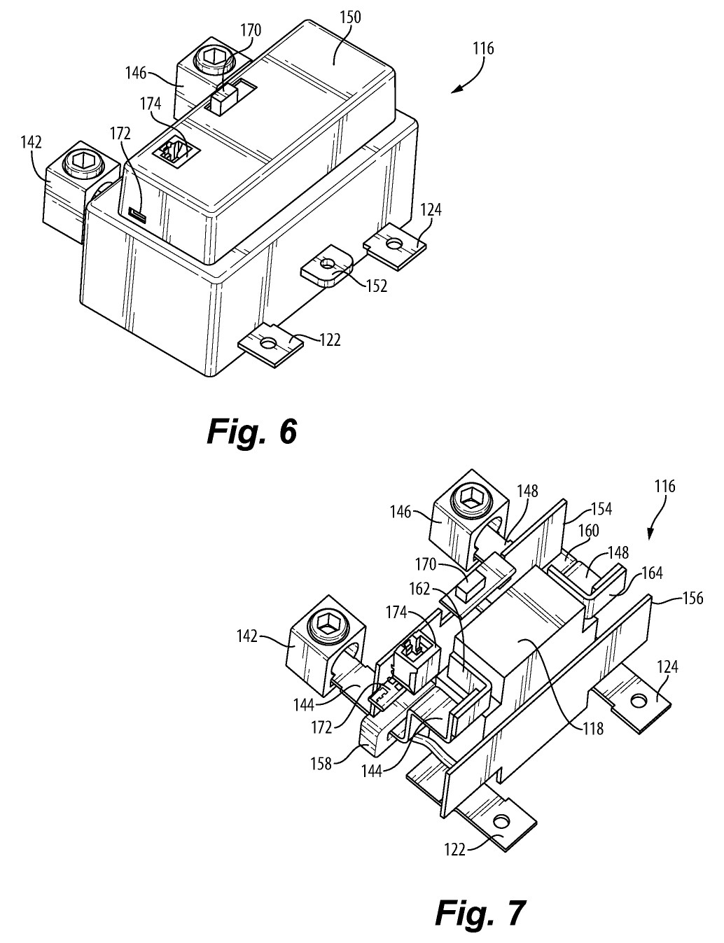

The system 100 includes a breaker panel 102, e.g. a circuit breaker panel. An interior 104 (labeled in FIGS. 2-5) is mounted in the breaker panel 102. As shown in FIG. 4, the interior 104 includes a first line bus 106 and a second line bus 108 and a plurality of connectors 110 configured to receive branch devices 112 for controlling individual circuits, e.g., of a residence, via wires 114 electrically connected to the respective branch devices 112. A main switching device 116 is mounted to the interior 104 (as shown in FIG. 4) which can be referred to as an islanding switch, a backup control switch (BCS) or a microgrid interconnect device (MID). The main switching device includes a relay 118, e.g., a relay rated for 200A. In an ON state of the relay 118, the relay 118 electrically connects the first line in L1 from a utility grid 120 to the first bus connector 122 (labeled in FIGS. 6-7) of the relay 118, which is in turn electrically connected to the first line main bus 106 (labeled in FIGS. 3-4). Similarly, in the ON state of the relay 118, the relay 118 electrically connects the second line in L2 from the utility grid 120 to the second bus connector 124 (labeled in FIGS. 6-7) of the relay 118, which in turn is electrically connected to the second line main bus 108 (labeled in FIGS. 3-4). In an OFF state of the relay 118, the relay is configured to electrically isolate the first line in L1 from the first bus connector 122 (labeled in FIGS. 6-7), and consequently from the first line main bus 106 (labeled in FIGS. 3-4), and to electrically isolate the second line in L2 from the second bus connector 124 (labeled in FIGS. 6-7) and consequently from the second line main bus 108 (labeled in FIGS. 3-4).

With reference now to FIGS. 2-5, a method of retrofitting a traditional breaker panel to become the system 100 of FIG. 1 is described. Starting from the state of FIG. 2, the method includes removing a main breaker 126 from a main receptacle 128 of the interior 104, as indicated by the large arrow in FIG. 3. This can include disconnecting respective lugs of the main breaker 126 from the first and second lines in L1, L2. The main breaker 126 can be a molded case circuit breaker, and the main receptacle can be dimensioned and shaped to fit tightly around the molded case circuit breaker form factor of the main breaker 126. The main switching device 116 is installed into the main receptacle 128 to replace the original main breaker 126, which includes electrically connecting the first bus connector 122 to the first line main bus 106 and electrically connecting the second bus connector 124 to the second line main bus 108 as shown in FIG. 4. The method includes optionally installing the main breaker 126 outside of the breaker panel 102, electrically in series in both lines in L1, L2 between the utility grid 120 and the main switching device 116 for use as a firefighter disconnect, as shown in FIG. 3, for disconnection of the first and second line main busses 106, 108 from the utility grid 120 even with the main switching device 116 of FIG. 4 in the ON state. The main circuit breaker 126 can provide main circuit breaking protection in addition to being a firefighter disconnect.

With reference now to FIG. 4, the method includes mounting a generator control switch (GCS) device 130 to the interior 104, and electrically connecting the GCS device 130 to first and second line main busses 106, 108 of the interior 104 for suppling generator power to the first and second line main busses 106, 108 with the GSC device 130 in a generator ON state, and disconnecting generator power from the first and second line main busses 106, 108 with the GCS device 130 in a generator OFF state. The method includes operatively connecting the GCS device 130 to the main switching device 116 as shown in FIG. 4 for control of the generator ON and OFF states of the GCS device 130 by the main switching device 116.

Before removing the main breaker 126 of FIG. 2, the cover 132 is removed from the breaker panel 102 to access the interior 104. The cover 132 includes one or more branch device apertures 134 therethrough for access and visibility of the branch devices 112 and a main aperture 136 therethrough dimensioned to fit a face 138 of the main breaker 126. A face of the main switching device is dimensioned to fit the main aperture 136. The cover 132 is reinstalled after installing the main switching device 116 and GCS device 130, with a face 140 of the main switching device 116 fitting through the main aperture 136 (labeled in FIG. 2) without modifying the main aperture 136. Similarly the GSC device 130 can fit through one or more of the branch device apertures 134 without having to modify the one or more branch device apertures 134.

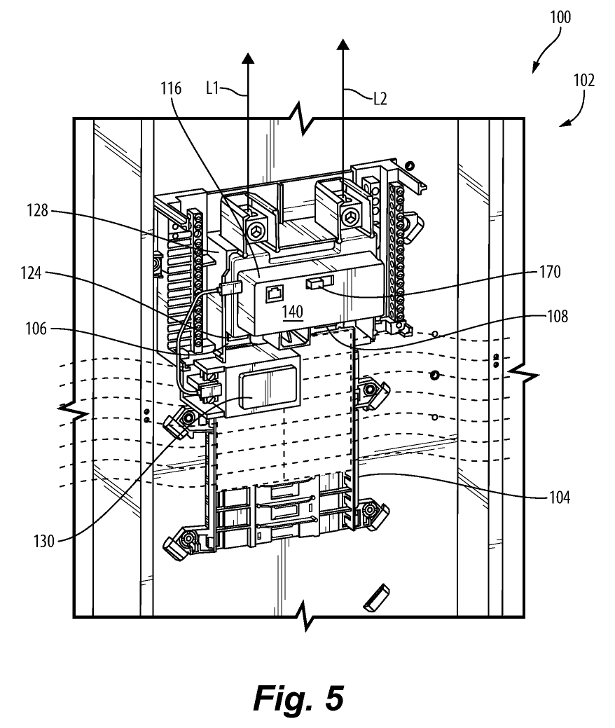

Prior to removing the cover 132 from the breaker panel 102 to access the interior 104 as shown in FIG. 2, the plurality of branch devices 112 can already be installed in position on the first and second line main busses 106, 108 and can already be connected with respective wires 114 to respective circuits for control of ON/OF states of the circuits. The plurality of branch devices 112 have faces that fit the one or more branch device apertures 134, as shown in FIG. 1. All of the branch devices 112 and their respective wires 114 can remain installed to the interior 104 before, during, and after removing the cover 132 (as shown in FIG. 2), removing the main breaker 126 (as shown in FIG. 3), installing the main switching device 116 (as shown in FIG. 4), installing the GCS device 130 (as shown in FIG. 5), and reinstalling the cover 132 (as shown in FIG. 1).

With reference now to FIGS. 6-7, the main switching device 116 includes a first lug 142 for connecting the first main line in L1 as shown in FIG. 4. The first lug 142 is electrically connected to the relay 118 by a first relay line in 144. A second lug 146 for connecting the second main relay line in 148 is electrically connected to the relay 118 by a second relay line in 148. The main switching device 116 further comprises a housing 150 with a mounting point 152 mounted to the interior 104. The housing 150 can fit in a QOM2 form factor, and the lugs 142, 146, the bus connectors 122, 124 and mounting point 152 all conform to the corresponding touch points of a QOM2 device. The bus connectors 122, 124 and mounting point 152 can each be affixed to the interior 104 as shown in FIG. 4 using fasteners, and the lugs 142, 146 can be connected mechanically and electrically to the main lines in L1, L2. FIG. 6 shows the main switching device 116 with the housing 150, and FIG. 7 shows the housing 150 removed to show the relay 118, PCBAs 154, 156 and line CTs (current transformers) 158, 160 that are inside the housing 150.

The first relay line in 144 extends from the first lug 142 outside the housing 150, as shown in FIG. 6, to a first terminal 162 the relay 118 inside the housing 150, as shown in FIG. 7. The second relay line in 148 extends from the second lug 146 outside the housing 150, as shown in FIG. 6, to a second terminal 164 of the relay 118 inside the housing 150, as shown in FIG. 7. The housing 150 is accommodated in the main receptacle 128 of the interior 104, as shown in FIG. 4. The lugs 142, 146, bus connectors 122, 124, and mounting point 152 can all be touch points of the main switching device 116 that match the corresponding touch points in the same positions with respect to the interior 104, which facilitates replacing the main breaker 126 with the main switching device 116.

With reference now to FIG. 7, the main switching device further comprises a lockout tagout (LOTO) switch 170 operatively connected to the relay 118 for manual control of the relay 118 for switching the relay 118 among the ON state and the OFF state. The main switching device 116 includes the communications PCBA (printed circuit board assembly) 154 including at least one input/output port such as the wired connection connectors 172, 174 for USB-C and ethernet, respectively, and/or wireless connectivity ports for Wi-Fi, Bluetooth, or the like. The communications PCBA 154 is operatively connected to control the relay 118 based on input received by the communications PCBA 154. The method can include connecting an external device 166 to the main switching device 116 as shown in FIG. 4, e.g. via the ethernet port or connector 174 to download usage metrics from the main switching device 116, control the main switching device 116, and/or upload a program into the main switching device 116 for automated operation of the main switching device 116 or the like. The program can include any suitable machine readable instructions, e.g. configured to manage daily peak rates connecting and disconnecting the breaker panel 102 from the utility grid 120 of FIG. 1 on a daily basis to optimize peak usage versus peak utility rates.

With continued reference to FIG. 7 the first line CT 158 is operatively connected to the first relay line in 144 to generate feedback signals indicative of electrical current in the first relay line in 144. The second line CT 160 is operatively connected to the second relay line in 148 to generate feedback signals indicative of electrical current in the second relay line in 148. The controller PCBA 156 is operatively connected to the first line CT 158, to the second line CT 160, and to the relay 118 for control of the relay 118, for switching the relay back and forth between the ON state and the OFF state of the relay 118 based on the feedback signals from the first and second line CTs 158, 160, and based on input received by the communications PCBA 154, such as user control signals, wired or wireless signals from a remote automated control system, or the like. The PCBA 156 can include components such as a power supply, e.g. a low voltage power supply for powering the PCBAs 154, 156, and voltage taps for the main lines L1, L2.

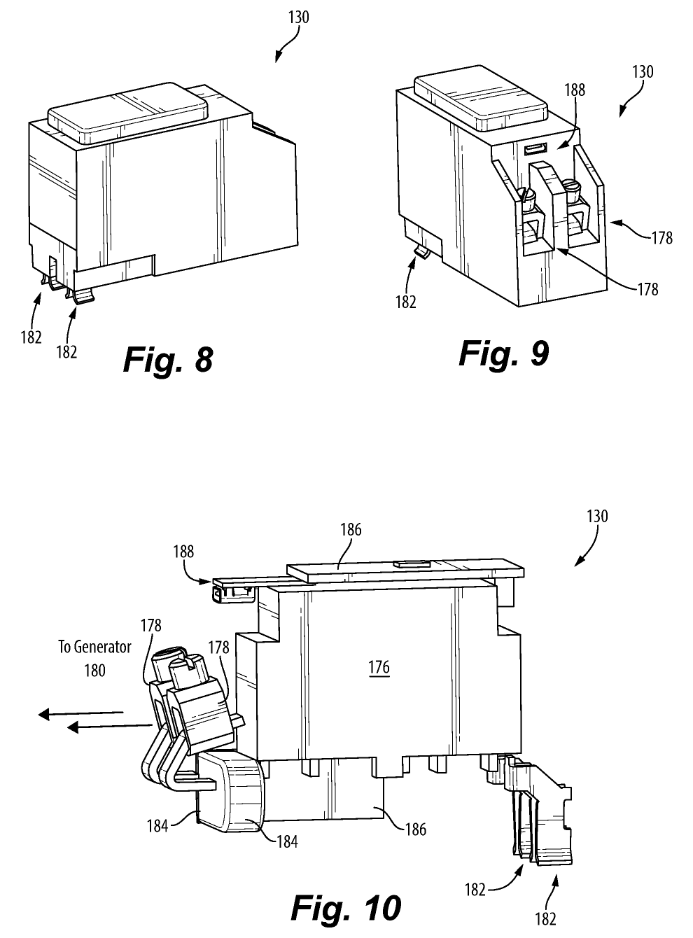

With reference now to FIGS. 8-10, the GCS device 130 of FIG. 5 includes relay 176, e.g. a 100A two pole relay, with lugs 178 for electrical connection of the GSC device 130 to a generator 180. The GCS device 130 includes two connectors 182 that are electrically connected to the first and second line main busses 106, 108, respectively during installation as shown in FIG. 5. Respective line CTs 184 are operatively connected to provide feedback indicative of electrical current in the generator lines in, e.g. at lugs 178. The PCBA 186 of the GCS device 130 includes an input output connector 188, e.g. a USB-C connector, and has a form factor fitting in a receptacle of the interior 104 for a QO two pole form factor. As shown in FIGS. 8 and 9, a housing 190 of the GCS device 130 encloses the relay 176, CTs 184, and PCBA 186.

A GCS control is included in the PCBA 186, configured to switch the GCS device 130 between a generator ON state for electrically connecting a generator 180, inverter, or direct current source such as solar panels or the like, to the first and second line main busses 106, 108 and a generator OFF state for electrically isolating the generator 180, or the like, from the first and second line main busses 106, 108. The method includes connecting the input output connector 188 to the connector or port 172 of the main switching device 116, as shown in FIG. 5, for control of the GCS device by the main switching device 116, e.g. to ensure the utility grid 120 of FIG. 1 and generator 180 are never both connected to the first and second line main busses 106, 108 at the same time.

Systems and methods as disclose herein provide for automation of isolating a residential breaker panel from a utility grid, which can be used, e.g., on a daily basis to time shift peak residential loads to be offset from peak utility rates to reduce overall power cost to the residence, to sell surplus power from the residence at peak rates, or the like. Systems and methods as disclosed herein allow for replacing a traditional main breaker with a MID/BCS, keeping all the touch points and form factor the same for ease of retrofitting.

The methods and systems of the present disclosure, as described above and shown in the drawings, provide for a relay based main switching device, e.g. for automation for functionality like time shifting of peak loads, and a method of retrofitting traditional breaker panels to incorporate the relay based main switching device. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A switching device comprising:a relay;a first lug electrically connected to the relay by a first relay line in;a second lug electrically connected to the relay by a second relay line in;a first bus connector electrically connected to the relay; anda second bus connector electrically connected to the relay, wherein in an ON state of the relay, the relay is configured to electrically connect the first relay line in to the first bus connector and to electrically connect the second relay line in to the second bus connector, and wherein in an OFF state of the relay, the relay is configured to electrically isolate the first relay line in from the first bus connector and to electrically isolate the second relay line in from the second bus connector.

2. The switching device as recited in claim 1, further comprising a housing with a mounting
point configured for mounting the housing to a breaker panel interior, wherein the relay is inside the housing, wherein the first relay line in extends from the first lug outside the housing to the relay inside the housing, and wherein the second relay line in extends from the second lug outside the housing to the relay inside the housing.

3. The switching device as recited in claim 1, further comprising a communications PCBA (printed circuit board assembly) including at least one input/output port operatively connected to control the relay based on input received by the communications PCBA.

4. The switching device as recited in claim 1, further comprising:a first line current transformer (CT) operatively connected to the first relay line in to generate feedback signals indicative of current in the first relay line in;a second line CT operatively connected to the second relay line in to generate feedback
signals indicative of current in the second relay line in; anda controller PCBA (printed circuit board assembly) operatively connected to the first line CT, to the second line CT, and to the relay for control of the relay, switching the relay back and forth between the ON state and the OFF state based on the feedback signals from the first line CT and from the second line CT.

5. The switching device as recited in claim 4, further comprising a lockout tagout (LOTO) switch operatively connected to the relay for manual control of the relay for switching the relay among the ON state and the OFF state.

6. A system comprising:a breaker panel;an interior mounted in the breaker panel, the interior including a first line bus and a second line bus and a plurality of connectors configured to receive branch devices for controlling individual circuits; anda main switching device including:a relay;a first lug electrically connected to the relay by a first relay line in;a second lug electrically connected to the relay by a second relay line in;
a first bus connector electrically connected to the relay and to the first line bus;
and a second bus connector electrically connected to the relay and to the second line bus, wherein in an ON state of the relay, the relay is configured to electrically connect the first
relay line in to the first bus connector and to electrically connect the second relay line in to the second bus connector, and wherein in an OFF state of the relay, the relay is configured to electrically isolate the first relay line in from the first bus connector and to electrically isolate the second relay line in from the second bus connector.

7. The system as recited in claim 6, wherein the main switching device further comprises a housing with a mounting point mounted to the interior, wherein the relay is inside the housing,
wherein the first relay line in extends from the first lug outside the housing to the relay inside the housing, and wherein the second relay line in extends from the second lug outside the housing to the relay inside the housing, and wherein the housing is accommodated in a receptacle of the
interior configured to receive a device of a QOM2 form factor.

8. The system as recited in claim 6, wherein the main switching device further comprises a communications PCBA (printed circuit board assembly) including at least one input/output port operatively connected to control the relay based on input received by the communications PCBA.

9. The system as recited in claim 8, further comprising a generator control switch (GCS) device mounted to the interior, wherein the GSC device includes a GCS control configured to switch the GCS device between a generator ON state for electrically connecting a generator to
the first and second line main busses and a generator OFF state for electrically isolating the generator from the first and second line main busses, wherein the GCS control includes an input output connector operatively connected to the at least one input/output port of the main switching device for control of the GCS device by the main switching device.

10. The system as recited in claim 6, wherein the main switching device further comprises:a first line current transformer (CT) operatively connected to the first relay line in to generate feedback signals indicative of current in the first relay line in;a second line CT operatively connected to the second relay line in to generate feedback
signals indicative of current in the second relay line in; anda controller PCBA (printed circuit board assembly) operatively connected to the first line CT, to the second line CT, and to the relay for control of the relay, switching the relay back and forth between the ON state and the OFF state based on the feedback signals from the first line CT and from the second line CT.

11. The system as recited in claim 10, wherein the main switching device further comprises a lockout tagout (LOTO) switch operatively connected to the relay for manual control of the relay for switching the relay among the ON state and the OFF state.

12. The system as recited in claim 6, further comprising a fireman disconnect device electrically connected to first and second main lines outside of the panel for allowing disconnection of the first and second main line main busses from a utility grid.

13. Method of retrofitting comprising:
removing a main breaker from a main receptacle of a breaker panel interior; and
installing a main switching device that includes a relay into the main receptacle of the breaker panel interior.

14. The method as recited in claim 13, further comprising installing the main breaker outside of the breaker panel, electrically in series between a utility grid and the main switching device for use as a firefighter disconnect.

15. The method as recited in claim 13, further comprising:mounting a generator control switch (GCS) device to the interior; andelectrically connecting the GCS device to first and second line main busses of the interior for suppling generator power to the first and second line main busses with the GSC in a generator ON state, and disconnecting generator power from the first and second line main
busses with the GCS in a generator OFF state.

16. The method as recited in claim 15, further comprising operatively connecting the BCS to the main switching device for control of the generator ON state and the generator OFF state by the main switching device.

17. The method as recited in claim 13, further comprising removing a cover from the breaker panel to access the interior before removing the main breaker, wherein the cover includes one or
more branch device apertures therethrough for branch devices and a main aperture therethrough dimensioned to fit a face of the main breaker.

18. The method as recited in claim 17, wherein a face of the main switching device is
dimensioned to fit the main aperture, and further comprising reinstalling the cover after installing the main switching device, with the face of the main switching device fitting the main aperture without modifying the main aperture.

19. The method as recited in claim 18, wherein prior to removing the cover from the breaker
panel to access the interior, a plurality of branch devices are installed on the first and second line main busses and are connected with respective wires to circuits for control of ON/OF states of the circuits, wherein the plurality of branch devices have faces that fit the one or more branch device apertures, and wherein all of the branch devices and their respective wires remain installed to the interior before, during, and after removing the cover and reinstalling the cover.

20. The method as recited in claim 13, further comprising connecting an external device to the main switching device to download usage metrics from the main switching device, control the main switching device, and/or upload a program into the main switching device.
